(19) United States
(12) Patent Application Publication
(10) Pub. No.: US 2024/0061965 A1
(43) Pub. Date: Feb. 22, 2024

(54) TOPOLOGY OPTIMIZATION WITH LOCALLY DIFFERENTIABLE COMPLEMENT SPACE CONNECTIVITY

(71) Applicant: PALO ALTO RESEARCH CENTER INCORPORATED, Palo Alto, CA (US)

(72) Inventors: Clinton Morris, San Carlos, CA (US); Amirmassoud Mirzendehdel, San Mateo, CA (US); Morad Behandish, Mountain View, CA (US)

(21) Appl. No.: 18/086,048

(22) Filed: Dec. 21, 2022

Related U.S. Application Data
(60) Provisional application No. 63/398,636, filed on Aug. 17, 2022.

(51) Int. Cl. G06F 30/10; G06F 30/23

(52) U.S. Cl. CPC G06F 30/10; G06F 30/23; G06F 2111/04

(57) ABSTRACT

One or more physical constraints are selected from a plurality of physical constraints for a part. The physical constraints are for use by a physics solver and define a physical performance of the part. One or more connectivity constraints are defined for use by the physics solver. The connectivity constraints enforce connectivity to or from at least one region over a complement space of the part. The connectivity constraints include locally differentiable violation measures that are modeled after at least one of the physical constraints. A topology of the part is optimized in the physics solver by enforcing the physical constraints and the connectivity constraints while satisfying a primary objective function that optimizes the physical performance of the part. A computer-aided design of the part is produced based on the optimized topology.

### RELATED PATENT DOCUMENTS

This application claims the benefit of U.S. Provisional Application No. 63/398,636, filed on Aug. 17, 2022, which is incorporated herein by reference in its entirety.

### STATEMENT REGARDING FEDERALLY SPONSORED RESEARCH OR DEVELOPMENT

This invention was made with government support under contract number G011.3809.00 awarded by Defense Advanced Research Projects Agency (DARPA). The government has certain rights in the invention.

### SUMMARY

Embodiments described herein include methods and systems for topology optimization with locally differentiable complement space connectivity. In one embodiment, a method involves defining one or more physical constraints selected from a plurality of physical constraints for a part. The one or more physical constraints are for use by a physics solver and define a physical performance of the part. One or more connectivity constraints are defined for use by the physics solver. The one or more connectivity constraints enforce connectivity to or from at least one region over a complement space of the part. The one or more connectivity constraints comprise locally differentiable violation measures that are modeled after at least one of the physical constraints. The method further involves optimizing a topology of the part in the physics solver by enforcing the one or more physical constraints and the one or more connectivity constraints while satisfying a primary objective function that optimizes the physical performance of the part. A computer-aided design of the part is produced based on the optimized topology. The computer-aided design used to produce the part via a manufacturing instrument.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures. The drawings are not necessarily to scale.

FIG. 1 is diagram of a general design domain considered in topology optimization according to an example embodiment;

FIG. 2 is a diagram illustrating how connectivity constraints are translated into virtual boundary conditions for virtual compliance formulation according to an example embodiment;

FIG. 3 is a flowchart of topology optimization workflow according to an example embodiment;

FIG. 4 is a diagram of a two-dimensional cantilever beam example with a fixed inlet and different outlets used for a parameter study;

FIG. 5 is diagram showing the location of different outlets usable with the beam shown in FIG. 4;

FIG. 6 is a set of plots showing topology optimization results of the beam in FIG. 4 where the outlet location was varied to the indicated locations in FIG. 5 using a method according to an example embodiment;

FIGS. 7A and 7B are sets of plots showing topology optimization of the example shown in FIGS. 4 and 5 where connectivity weight was varied using a method according to an example embodiment;

FIG. 8 is a diagram of a two-dimensional cantilever domain where connectivity was enforced with an obstacle between inlet and outlet;

FIG. 9 is a set of plots showing topology optimization of the example shown in FIG. 8 using a method according to an example embodiment;

FIGS. 10 and 12 are diagrams of two-dimensional cantilever domains used for structural compliance minimization parameter studies;

FIGS. 11 and 13 are sets of plots showing topology optimization of the respective examples shown in FIGS. 10 and 12 using a method according to an example embodiment;

FIG. 14 is a diagram illustrating the domain used for a structural compliance minimization problem with connectivity enforcement in three dimensions;

FIGS. 15A and 15B are sets of plots showing topology optimization of the example shown in FIG. 14 using a method according to an example embodiment;

FIG. 16 is a set of plots showing topology optimization of the example shown in FIG. 10 using a method according to another example embodiment; and

FIG. 17 is a block diagram of a system according to an example embodiment.

### DETAILED DESCRIPTION

The present disclosure relates to automated optimization of designs for manufactured parts and assemblies. Enforcing connectivity of parts or their complement space during automated design is used for various manufacturing and functional considerations such as removing powder, wiring internal components, and flowing internal coolant. The global nature of connectivity makes it difficult to incorporate into generative design methods that rely on local decision making, e.g., topology optimization (TO) algorithms whose update rules depend on the sensitivity of objective functions or constraints to locally change the design. Connectivity is commonly corrected for in a post-processing step, which may result in suboptimal designs.

Methods described herein recast the connectivity constraint as a locally differentiable violation measure, defined as a “virtual” compliance, modeled after physical (e.g., thermal or structural) compliance. Such measures can be used within TO alongside other objective functions and constraints, using a weighted penalty scheme to navigate tradeoffs. By carefully specifying the boundary conditions of the virtual compliance problem, the designer can enforce connectivity between arbitrary regions of the part's complement space while satisfying a primary objective function in the TO loop. We demonstrate the effectiveness of our approach using both 2D and 3D examples, show its flexibility to consider multiple virtual domains, and confirm the benefits of considering connectivity in the design loop rather than enforcing it through post-processing.

Topology optimization (TO) has emerged as a useful tool for generating complex geometries whose intricacies extend beyond the design capabilities of human designers. Generally, the material is laid out to optimize performance metrics determined by physics-based solvers based on numerical methods such as finite element analysis (FEA). The rise of TO as an automated design tool has coincided with a number of advancements in additive manufacturing (AM) which allow for the fabrication of complex geometries that were previously infeasible.

The manufacturing freedom afforded by AM is not unlimited, though. AM imposes a new set of complex constraints on feasible material distributions and geometries. Design for AM (DfAM) has focused on identifying and incorporating these constraints into design frameworks. The incorporation of manufacturing constraints into the TO framework can be broadly classified into two approaches which are (1) post-processing optimized part after generation; and (2) incorporating the constraints into the optimization loop.

The post-processing approach generally results in suboptimal designs with respect to the optimized objective functions. For example, when considering powder removal after selective laser sintering (SLS), the part's optimized structural stiffness can be adversely affected after drilling holes to reach internal cavities to facilitate powder removal. Whenever possible, it is preferable to incorporate manufacturing constraints, such as connectivity between internal cavities and exterior space, into the optimization process, as opposed to introducing them later.

Connectivity of the complement space is only one example of a manufacturing constraint that is considered to design functional parts. Other examples are lower-bounding minimum feature size, avoiding excessive overhangs to ensure self-supporting structures for fused deposition modeling (FDM), and enforcing accessibility of the complement space by machine tools. Incorporating these constraints into TO frameworks hinges on the ability to locally evaluate them—or their violations, to penalize TO objective functions via continuous measures which are differentiable with respect to local changes in the design representation, such as density fields.

Connectivity is a global constraint which cannot be directly differentiated with respect to the design representation. Although its global nature is problematic for its incorporation into a TO framework, enforcing connectivity of interior and exterior space (the part and its complement) is essential in multiple design contexts. For example, complement space connectivity (CSC) can be used when designing parts requiring connected channels for powder removal after SLS, wiring across mounted components on the part surface or within its interior cavities, embedded conductors, coolant fluid flow, etc. Earlier studies applied path finding algorithms that use combinatorial search such as A* to find the shortest path between specified points within the interior of a part. However, such methods do not provide a locally evaluable measure to incorporate into TO, thus can only be used in post-processing leading to suboptimal parts.

Enforcing CSC in TO was considered to eliminate entrapped powder or resin for AM parts by ensuring that all internal cavities were connected to the boundaries of the design domain. The approach recasts the connectivity enforcement problem as a maximum “virtual” temperature minimization which leads to a simply-connected complement space, resulting in a design in which no standalone disconnected cavities are created. This approach was extended such that the location of internal cavities could be partially specified by imposing additional internal Dirichlet boundary conditions (fixed virtual temperatures) at locations where a cavity is desired. With this modified approach, the complement space is not necessarily simply-connected. The previous implementations, specifically the exclusive use of Dirichlet boundary conditions in the virtual problem, though, cannot ensure any two points are connected in the void space which is necessary when considering wiring between mounted and embedded components.

A similar physics-inspired approach can be used to enforce CSC in TO that can be composed with other physics-based performance criteria such as structural stiffness or thermal conductance to enforce connectivity in the complement space between any two arbitrary points or regions. This approach can utilize minimization of a “virtual” energy function or compliance of a hypothetical structure representing the complement space, but utilizing both Neumann and Dirichlet boundary conditions to enforce the desired connectivity in the complement space. The approach involves combinatorial path finding (e.g., A*-based) methods that is able to generate locally evaluable sensitivity fields to incorporate into gradient-descent TO. To this end, the part and its complement are implicitly represented by the super- and sub-level sets of a density field. At each TO iteration, we use the density field and its negation to evaluate physical and artificial stiffness matrices needed to compute the corresponding quantities of interest using an FEA solver. As a result, designers can specify both physics-based performance criteria and CSC constraints and assign relative weights to navigate the tradeoffs between them.

One goal is to demonstrate that optimal topologies can be generated in such a way that two specified points or regions in the complement space are guaranteed to be path-connected. This approach allows the designer to enforce CSC in anticipation of embedded components that must be connected (e.g., conductors) or channels to enable powder removal in SLS or accommodate wires/cables, while simultaneously optimizing or physics-based performance criteria. The approach can be in principle extended to combine CSC with other manufacturability constraints that are also locally evaluable and differentiable (e.g., accessibility, self-support, and accessible support).

This disclosure introduces a general approach to enforce connectivity between arbitrary pairs of points in the design space during TO using “virtual” compliance measures. Complement space connectivity can be enforced while optimizing structural stiffness for representative 2D and 3D problem. The CSC can be incorporated into the TO loop, as opposed to post-process modifications of optimized parts, to avoid suboptimal designs and enable navigating tradeoffs between the design criteria.

The remainder of the disclosure is organized as follows: Section 2 describes the problem formulation; Section 3 provides preliminary parameter studies to finetune the virtual compliance and its weighted combination with physics-based structural stiffness; Section 4 demonstrates how incorporating CSC constraints into the TO loop can change the part structure relative to TO without CSC constraints, in nontrivial ways; Section 5 provides a conclusion of what was presented and future directions.

### 2. Connectivity Enforcement Formulation

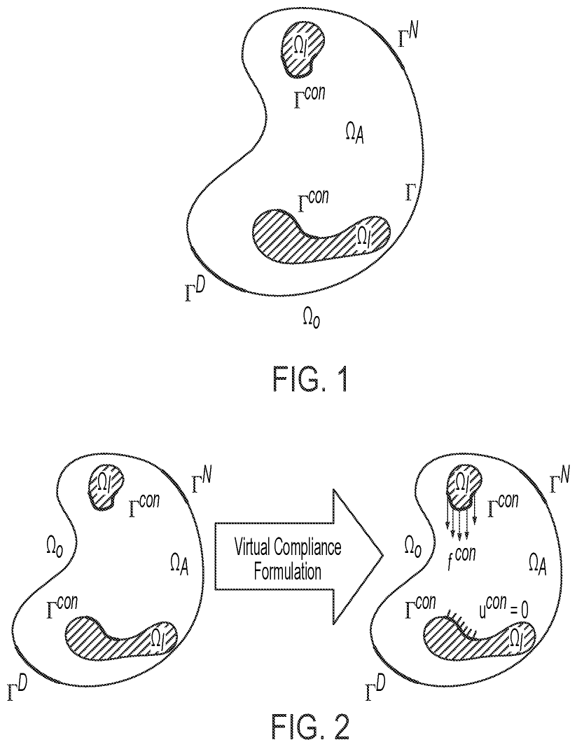

The diagram in FIG. 1 defines the terminology used in our approach. This figure shows A general design domain in TO with connectivity enforcement among two or more Γ^{N} patches. On the boundary Γ of the initial design domain Ω₀, one may specify physics-based Dirichlet and/or Neumann boundary conditions, Γ^{D} and Γ^{N}, respectively. In a mechanical context, these boundary conditions are displacements and loads, while in a thermal context, the boundary conditions are temperatures and heat fluxes. For density-based TO, a continuous density function, ξ Ω: Ω₀→[0,1] provides an implicit representation of a design Ω⊆Ω0. In other words, the design domain Ω0 is partitioned into active and inactive regions, Ω and (Ω₀−Ω), respectively, defined by super- and sub-level sets of the density field corresponding to prescribed thresholds, respectively. There are also connectivity boundaries, Γ^{CON}, that are connected in the complement space.

A typical (structural or thermal) TO problem (without CSC constraints) can be formulated as follows:

$$\begin{matrix}\begin{matrix}minimize \\ Ω ⊆ {Ω}_{0}\end{matrix} & φ ( Ω )\end{matrix} \qquad 1 ( a )$$

$$\begin{matrix}such that & [ {K}_{Ω} ] [ {u}_{Ω} ] = [ f ]\end{matrix} \qquad 1 ( b )$$

$${V}_{Ω} \leq {V}_{t a r g e t} \qquad 1 ( c )$$

where φ(Ω) ∈ R is the objective function (1a) over the design domain. The FEA arrays [f], [u_{Ω}], and [K_{Ω}] are the discretized external load vector, response vector, and stiffness matrix, respectively, whose relationship is constrained by (1b) resulting from physics-based governing equations. V_{Ω} is the volume of Ω that is upper-bounded in (1c) by a fixed budget V_{target}. In addition to these two constraints, we aim to introduce the CSC constraint in such a way that a local sensitivity field can be defined to penalize design modifications that compromise CSC.

To recast the CSC constraint into a locally differentiable form, we begin from a key observation that minimizing the (thermal or structural) compliance over a domain naturally leads to a path-connected structure joining the surfaces at which loads are applied (e.g., Neumann boundary conditions) to surfaces where the response to that load is fixed (e.g., Dirichlet boundary conditions). Intuitively, if such connectivity is violated, the part would undergo rigid motions, leading to zero-valued eigenvalues of the stiffness matrix used in the static equilibrium FEA. Therefore, to enforce connectivity in the complement space, we formulate a virtual compliance function over the design space, for the hypothetical response of a virtual part to virtual loads applied at Γ^{CON}

c_{Ω}^{con}=[f^{con}]^{T}[u_{Ω}^{con}]=[u_{Ω}^{con}][K_{Ω}^{con}][u_{Ω}^{con}] (2)

where [f^{con}], [[u_{Ω}^{con}], and [K_{Ω}^{con}] are the virtual discretized external load vector, displacement vector, and stiffness matrix, respectively. A variety of virtual physics-based interpretations could be selected, e.g., thermal physics would lead to scalar values for the load and response (namely, heat fluxes and temperatures) whereas structural physics would lead to vector values (namely, forces and displacement). The impact of the selected virtual physics will be explored later. In general, we specify Neumann boundary conditions at one region of Γ678, referred to as the ‘inlet’, and a Dirichlet boundary condition at another region, referred to as the ‘outlet’. The diagram in FIG. 2 provides an illustration for how the original domain of FIG. 1 translates to our virtual compliance problem using structural physics for (2).

With the CSC constraint recast into a locally differentiable form, we return to the primary TO problem to introduce how the virtual connectivity is incorporated. To begin, we ignore the connectivity constraint to form the prototypical Lagrangian, L_{Ω} for the primary TO:

$${L}_{Ω} = φ ( Ω ) + {λ}_{1} ( \frac{{v}_{Ω}}{{V}_{t a r g e t}} - 1 ) + {[ {λ}_{2} ]}^{T} ( [ {K}_{Ω} ] [ {u}_{Ω} ] - [ f ] ) \qquad ( 3 )$$

By performing a representation-agnostic differentiation of the Lagrangian with respect to Ω, we obtain

$${L}_{Ω}^{′} = ( [ \frac{\partial φ ( Ω )}{\partial u} ] + {[ {λ}_{2} ]}^{T} [ {K}_{Ω} ] ) [ {u}_{Ω}^{′} ] + {λ}_{1} \frac{{V}_{Ω}^{′}}{{V}_{t a r g e t}} + {[ {λ}_{2} ]}^{T} [ {K}_{Ω}^{′} ] [ {u}_{Ω} ] \qquad ( 4 )$$

Computation of [u′_{Ω}] is challenging, but (4) can be simplified by selecting [λ₂], one of the Lagrange multipliers, as the solution to the adjoint problem to obtain:

$${L}_{Ω}^{′} = {λ}_{1} \frac{{V}_{Ω}^{′}}{{V}_{t a r g e t}} - {( {[ {K}_{Ω} ]}^{- 1} [ \frac{\partial φ ( Ω )}{\partial u} ] )}^{T} [ {K}_{Ω}^{′} ] [ {u}_{Ω} ] \qquad ( 5 )$$

If the objective is the compliance, φ(Ω):=[f][[u_{Ω}], then [λ₂] reduces to −[u_{Ω}] because compliance is self-adjoint.

Let S_{φ}: Ω₀→ [symbol] represent the sensitivity field of the primary objective, that is the field provided by the second term on the RHS of (5). We can define a similar field S_{con}: Ω₀→ [symbol] for the virtual compliance used to quantify the violation of the CSC constraint. We use a weighted convex sum of the two fields, in which the weighting factor 0≤w_{con}≤1 controls the degree to which the CSC constraint is enforced and can either be static or dynamically changed during TO iterations:

S_{Ω}:=(1−w_{con})S_{φ}+w_{con}S_{con} (6)

where S_{φ}=−[u_{Ω}]^{T}[K′_{Ω}][u_{Ω}] and S_{con}=−[u_{Ω}^{con}]^{T} [K_{Ω}^{con}′][u_{Ω}^{con}]. With the formulation provided, we provide the CSC constrained formulation below for clarity where c_{Ω}^{φ} is the primary objective.

$$\begin{matrix}\begin{matrix}minimize \\ Ω ⊆ {Ω}_{0}\end{matrix} & ( 1 - {w}_{c o n} ) {c}_{Ω}^{φ} + {w}_{c o n} {c}_{Ω}^{c o n}\end{matrix} \qquad 7 ( a )$$

$$\begin{matrix}such that & [ {K}_{Ω} ] [ {u}_{Ω} ] = [ f ]\end{matrix} \qquad 7 ( b )$$

$$[ {K}_{Ω}^{c o n} ] [ {u}_{Ω}^{c o n} ] = [ f ] \qquad 7 ( c )$$

$${V}_{Ω} \leq {V}_{target} \qquad 7 ( d )$$

To generate results and provide more detail on how CSC is enforced, we use a density-based approach, namely the solid isotropic material penalization (SIMP) approach, although the idea is, in principle, extensible to other (e.g., levelset) TO methods. The primary objective in this approach is to minimize the structural compliance while enforcing connectivity in the complement space between two regions. We start with the density field, ξ_{Ω}: Ω₀→[0,1] that maps every point x ∈ Ω₀ in the design domain to a density value ξ_{Ω}(x) ∈ [0,1]. The discretization of the density field, [ξ_{Ω}], is a finite array of design variables in the range [0,1] to be optimized. To compute the elasticity for intermediate densities, we first use a Heaviside projection:

ρ₀(x)=1−e^{-βξ}^{_{Ω}}^{(x)}+ξ_{Ω}(x)e^{-β} (8)

in which we use β:=2 for 2D and β:=10 for 3D examples.

The discretized density field [ρ₀] can be mapped to a discretized elasticity field (e.g., elemental Young's modulus) as follows:

[E]=Eₘᵢₙ[1]+(Eₘₐₓ−Eₘᵢₙ)[ρ_{Ω}] (9)

where the elasticity bounds Eₘᵢₙ and Eₘₐₓ and the penalization parameter p>1 are constants. With the elemental Young's modulus defined, the elemental stiffness (which depends on the physics), and global stiffness matrix [KΩ] can also be formed in a standard fashion (see, e.g., Bendsøe, M. P., and Sigmund, O., 1999, “Material Interpolation Schemes in Topology Optimization,” Arch. Appl. Mech., 69(9), pp. 635-654.)

The virtual stiffness used to quantify the virtual compliance for CSC is defined in a similar fashion where the material interpolation scheme is used to determine the global stiffness matrix, [K_{Ω}^{con}] that depends on the desired virtual physics. The exception is that it uses the negation of the density field that implicitly represents the complement space:

[E^{con}]=Eₘᵢₙ[1]+(Eₘₐₓ−Eₘᵢₙ)[1−ρ_{Ω}] (10)

The impact of this negation will appear in the sensitivity field in (6) where the sign of S_{con} will be negated due to the chain rule applied to [K_{Ω}^{con}′] term. We use the method of moving asymptotes (MMA) (see, e.g., Svanberg, K., 1987, “The Method of Moving Asymptotes—a New Method for Structural Optimization,” Int. J. Numer. Methods Eng., 24(2), pp. 359-373) to update the discretized density during optimization rather than optimality criteria (OC), as the former provides a more straightforward path to optimizing non-convex functions. Additionally, it should be noted that the artificial material properties used in (10) need not be the same as those used for the primary problem.

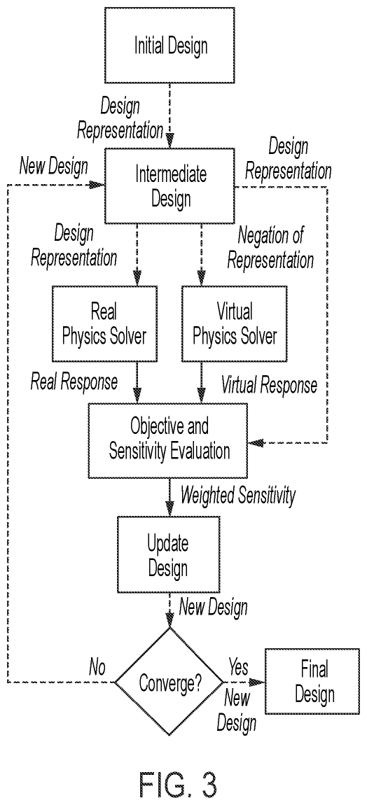

The diagram in FIG. 3 illustrates the TO workflow with CSC enforcement according to an example embodiment. In every design iteration, two FEA instances are called using the same or different solvers to compute the relevant responses for physical and virtual problems. These responses are then used to calculate the primary objective function and sensitivity fields, which are used in an update scheme, in this case MMA, to update the design iteratively.

### 3. Influence of Domain on Connectivity Enforcement

From the formulation of connectivity enforcement, there are multiple parameters that can influence the connectivity results. The most interesting is the virtual physics domain on which the virtual (e.g., thermal or mechanical) compliance is formulated. While previous work on connectivity enforcement focused on the thermal formulation, we investigate the impact of different physics on CSC enforcement within our framework.

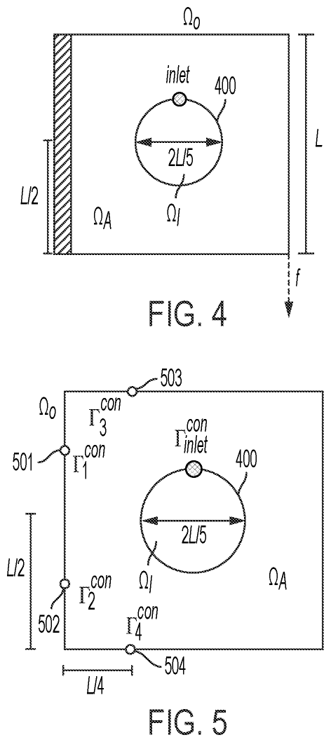

We performed three studies to both demonstrate the effectiveness of our approach for CSC enforcement and compare the impacts of each virtual physics domain. All three studies were performed on the same or slightly modified design domain shown in FIG. 4. In this domain, a fixed inlet 400 and different outlets were used for parameter studies. The inlet location for CSC is always on the boundary of the circular inactive domain directly above its center but the outlet is not shown because it will vary from study to study. The inactive domain is always void in this work. For all tests, the material properties and penalizations used are provided by Table 1 as well as the relevant parameters that were fixed for all case studies.

TABLE 1
Relevant parameters (fixed for all case studies).

| Parameter | Value |
|---|---|
| Eₘₐₓ | 1 |
| Eₘᵢₙ | 1E−9 |
| p | 3 |
| P^{CON} | 5 |
| β | 2 |

The first study was used to ensure the approach enforced connectivity between inlets and outlets regardless of virtual physics. Therefore, the domain shown in FIG. 5 was used where the location of the inlet 400 was fixed and the location of the outlet was varied, as indicated by outlet locations 501-504. To minimize confounding effects, this study does not consider the primary objective function based on the physical performance of the cantilevered structure. In other words, it is assumed that CSC is the only design criterion, which corresponds to w_{con}=1 in (7).

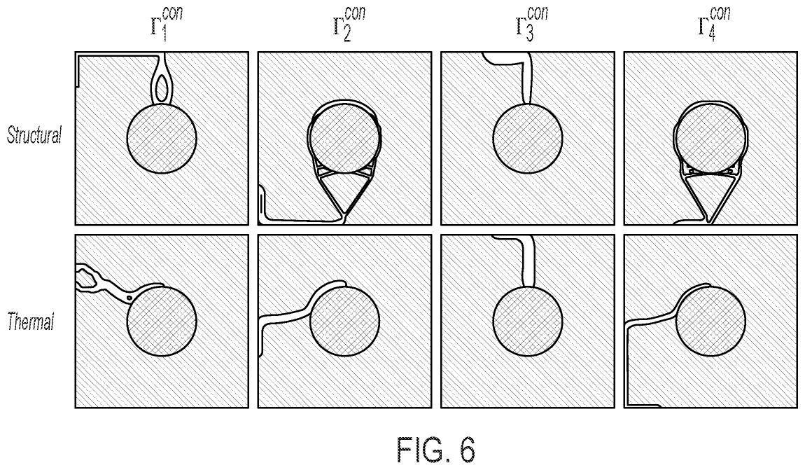

We used both thermal and structural formulations of the virtual compliance to enforce CSC. For the former, we applied a unit flux at the inlet 400 shown in FIG. 5, whereas for the latter, we applied a unit force in the negative Y-direction at the inlet 400. For both variants, we applied homogenous Dirichlet boundary conditions to each of the 4 indicated locations and used a constant target volume fraction of 0.85. The length of the Dirichlet boundary condition was 0.05 L to ensure stability. The results of the study are shown in FIG. 6 where the domain was a 400×400 voxel mesh. In the drawing, diagonal hatching indicates dense elements, white indicates active void elements, and cross-hatching indicates inactive void elements. The cross-hatched elements can be viewed as an embedded component as well but do not contribute to the primary or virtual compliance. These hatching conventions are consistent across all figures showing TO results for the remainder of the paper unless indicated otherwise.

The diagram in FIG. 6 shows the results from the first parameter study where the outlet location was varied to the four indicated locations. As shown in FIG. 6, CSC is enforced in the void, white space between inlets and outlets regardless of the position of the outlet and regardless of the virtual physics used. The top row was generated using a virtual structural compliance while the bottom row utilized a thermal compliance. Unsurprisingly, the resultant geometries differ across the virtual physics given the same inlet and outlet locations due to the fundamentally different physics being captured by (7c). This case study in which w_{con}=1 is equivalent to minimizing the structural or thermal compliance for a hypothetical material in the complement space.

Additionally, the location of the outlet (and inlet) drastically influence the final geometry of the part regardless of physics. If the location of the inlets and outlet is not defined a priori or can vary over some region, then it is unclear what the best locations are. Including the inlet/outlet locations as design variable in the optimization loop is an area of future work.

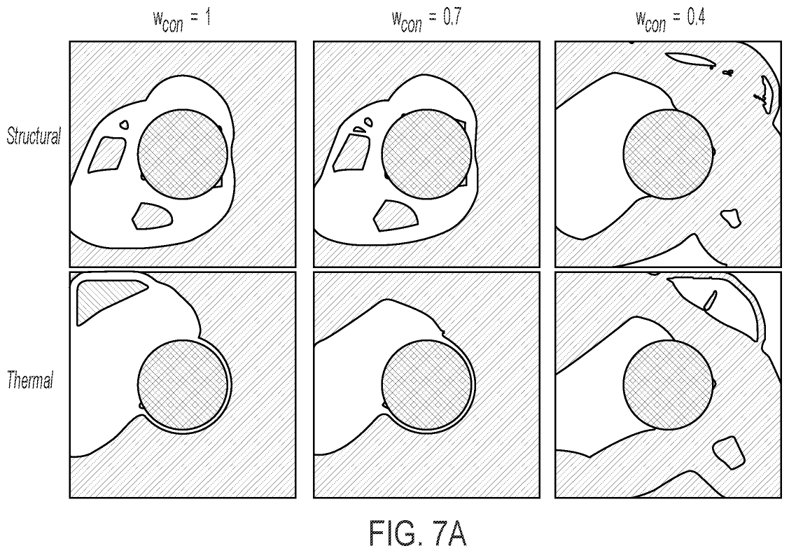

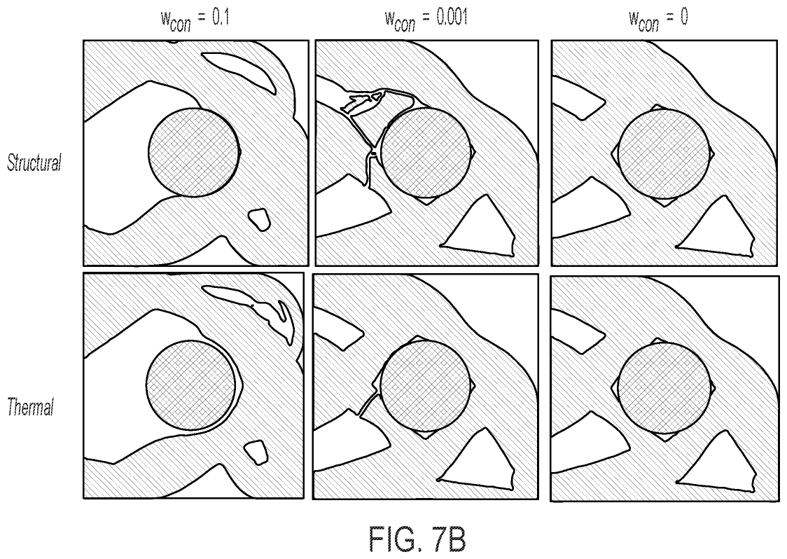

For the second case study, the purpose was to understand the impact of 0<w_{con}<1 on the optimized shape for both virtual domains. Therefore, the configuration shown in FIG. 5, where the outlet is located at Γ₂^{con} was used while varying w_{con}. The selected values for w_{con} were 1, 0.7, 0.4, 0.1, 1E-3, and 0, and the volume fraction target was 0.6. The resulting shapes are shown in FIGS. 7A and 7B, where the top row was generated using a virtual structural compliance while the bottom row utilized a thermal compliance.

It is clear that increasing w_{con} affects the resulting shape. As expected, when CSC is not enforced, the inlet and outlet are not connected. Once CSC is enforced, even for small w_{con}>0, the inlet and outlets are connected for both virtual physics, although the means by which connectivity is enforced for smaller weights varies significantly between the two virtual domains. It appears that the thermal formulation leads to more direct paths, while the structural domain favors paths with diverging and converging routes. As shown in FIGS. 7A and 7B, these complex routes can result in disconnected (floating) diagonally hatched regions. The avoidance of these disconnected regions could potentially be accomplished through filtering. As w_{con} is increased to more moderate values 0.1-0.6, the geometries are more similar across physics. For larger values of w_{con}, the geometries diverge once again, favoring the solutions of compliance minimization in the complement space.

Additionally, we computed the structural compliance of each structure as shown in Table 2 with the associated weights and virtual physics. The values are provided as ratios of the compliance to that of the extreme case w_{con}=0.

TABLE 2
Compliance values for a variety of connectivity weights
for enforcing CSC with two different virtual physics

Compliance ratio

| w_{con} | Structural | Thermal |
|---|---|---|
| 1 | 2.03 | 1.86 |
| 0.7 | 1.48 | 1.55 |
| 0.4 | 1.38 | 1.34 |
| 0.1 | 1.24 | 1.15 |
| 0.001 | 1.00 | 1.00 |
| 0 | 1.00 | 1.00 |

As w_{con} is increased, the primary structural compliance also increased. There is good agreement between the values across the virtual physics domains, indicating that the selected physics do not drastically affect the performance with respect to the primary objective function, although, this may not always be the case.

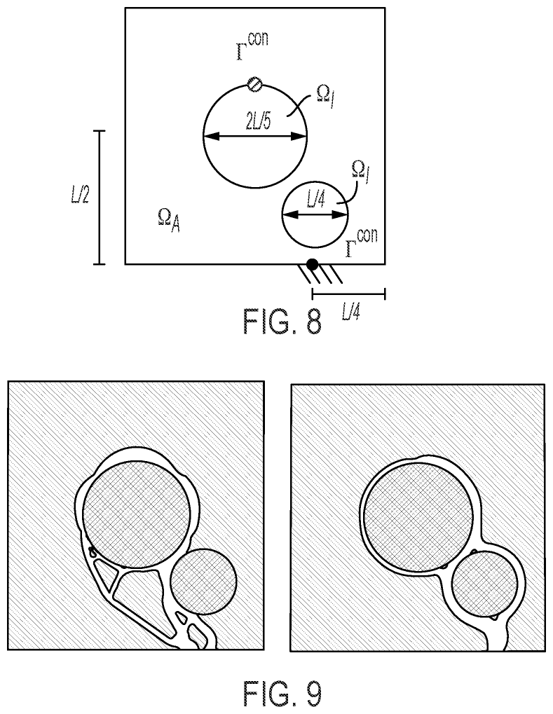

The final case study was to understand the behavior of the approach when an obstacle is introduced along with a low void material budget (high target volume fraction). The domain is shown in the diagram of FIG. 8 where an additional inactive domain is added to the domain of FIG. 4 as an obstacle and the outlet is specified by Γ^{con}. Once again, we considered no primary physical criterion for connectivity enforcement and the results are shown in FIG. 9 where we used a desired volume fraction of 0.85.

Once again, we see both domains enforce connectivity, but the thermal domain creates more direct paths while the structural domain creates more complex paths. It should be noted that the computational complexity of solving the thermal finite element problem is significantly smaller than that of the structural domain due to the number of degrees of freedom. It seems then, that the virtual thermal domain is likely preferable to the structural domain unless there is a need for complex pathways.

### 4. Enforcing Connectivity During Design Generation

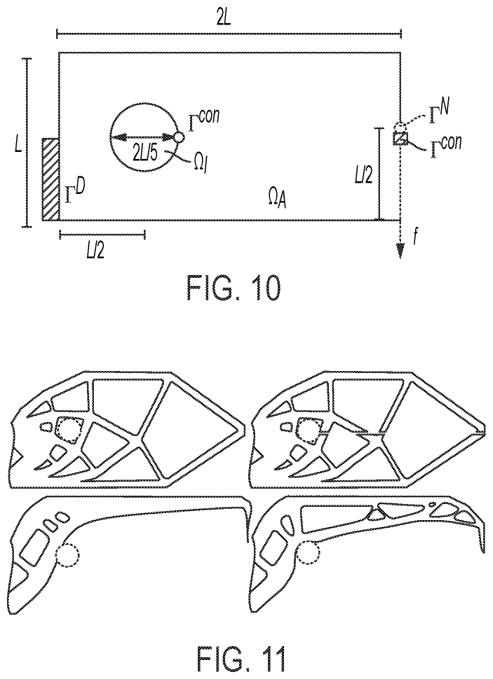

This section presents the impact of incorporating CSC into the TO loop on the shape/topology and physical performance of structurally optimized parts compared to unconstrained TO followed by post-process correction for CSC. We show that that latter may result in designs with drastically lower performance. The first example is in 2D where we used the domain shown in FIG. 10. The design is like a cantilevered beam but only half of the domain on the left-hand side is fixed to the wall and the load is applied at the midpoint of the right-hand face. The desired CSC is between a point on the inactive domain boundary and a point slightly below the applied force. This example can represent an embedded circular component that needs wiring to connect to an external point near the applied force. The inlet is the point on the inactive domain boundary and the outlet is the other points. Both thermal and structural formulations are once again considered for virtual compliance. For the thermal domain a unit flux is applied at the inlet and for the structural domain a unit downward force in the y-direction is applied at the inlet for connectivity enforcements. This domain is intended to represent an embedded component that needs to be connected to another component mounted on the right-hand boundary.

With the domain established, we selected a target volume fraction of 0.25 and generated four optimized designs on a 400×200 voxel mesh. The results are shown in the plots of FIG. 11. The first design (top left of FIG. 11) did not consider connectivity (w_{con}=0). The second design (top right of FIG. 11) was generated by removing material between inlet and outlet after generating a structure in which connectivity is not enforced (w_{con}=0). The third (bottom left of FIG. 11) and fourth (bottom right of FIG. 11) designs were generated using w_{con}=0.9 using both thermal and structural virtual physics for enforcing CSC, respectively. In, FIG. 11, black indicates dense elements, white indicates active void elements, and hatched elements are inactive, void elements.

The example in FIG. 11 shows that without enforcing CSC, the desired points are not connected in the complement space. Once connectivity is considered though, a path in the complement space is formed which dramatically changes the shape of the structure. Once again, the shapes are similar when connectivity is enforced regardless of the virtual physics used for CSC. When comparing the compliances, the unconstrained TO's outcome is 5.22 and 4.68 times stiffer compared to the CSC constrained TO's outcomes, using virtual thermal and structural compliance in the TO loop, respectively. While the change in compliance is significant, the unconstrained structure is 3900 times stiffer than the post-processed structure where connectivity was enforced by removing a path between inlet and outlet after TO. To ensure structural integrity, the connectivity constraint should be considered in the design loop.

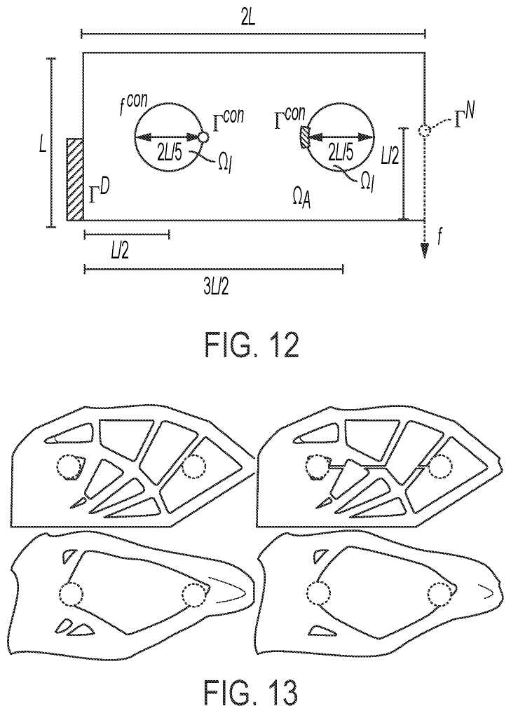

In FIG. 12, a diagram shows a domain of another 2D example. The design is like a cantilevered beam but only half of the domain on the left-hand side is fixed to the wall and the load is applied at the bottom right corner. The desired connectivity is between two points on the boundaries of two inactive domains. The inlet is the point on the left inactive domain boundary and the outlet is the other point. This domain is intended to represent two embedded components needing to be internally connected within a cantilevered structure.

We selected a target volume fraction of 0.5 and, once again, four designs were generated on a 400×200 voxel mesh. The first design did not consider connectivity (w_{con}=0). The second design was generated by removing material between inlet and outlet after generating a structure in which connectivity is not enforced (w_{con}=0). The third and fourth designs were generated using w_{con}=0.5 using both thermal and structural virtual physics for enforcing CSC, respectively. The results are shown in FIG. 13 where black indicates dense elements, white indicates active void elements, and hatched elements are inactive void elements.

The results shown in FIG. 13 demonstrates that without enforcing CSC, the desired points are not connected in the complement space. Once connectivity is considered though, a path in the complement space is formed which changes the shape of the structure. Matching intuition, the structural features between the two inactive regions were eliminated. Interestingly, the removal of these members resulted in multiple other changes in shape to compensate for the decrease in rigidity and the additional material budget for both CSC constrained structures.

To once again demonstrate the need to enforce CSC in the design loop, the compliances were computed for all of the structures show in FIG. 13. The normalized compliance relative to the compliance of the unconstrained and unprocessed structure, c₀, for all four structures is provided by Table 3. Table 3 shows that the stiffness is vastly inferior for the postprocessed part while the stiffness is only slightly reduced when connectivity is considered in the design loop.

TABLE 3
Normalized compliance results for the three generated topologies

| Design parameters | c/c₀ |
|---|---|
| w_{con} = 0, no post process | 1.00 |
| w_{con} = 0, post-process | 224.74 |
| w_{con} = 0.5, thermal | 1.14 |
| w_{con} = 0.5, structural | 1.24 |

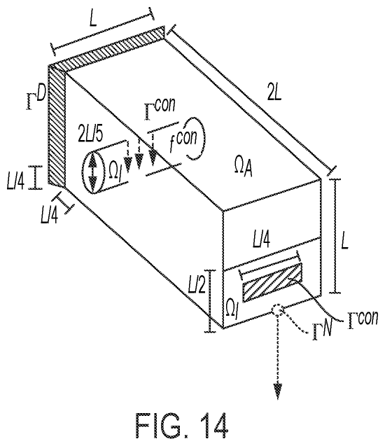

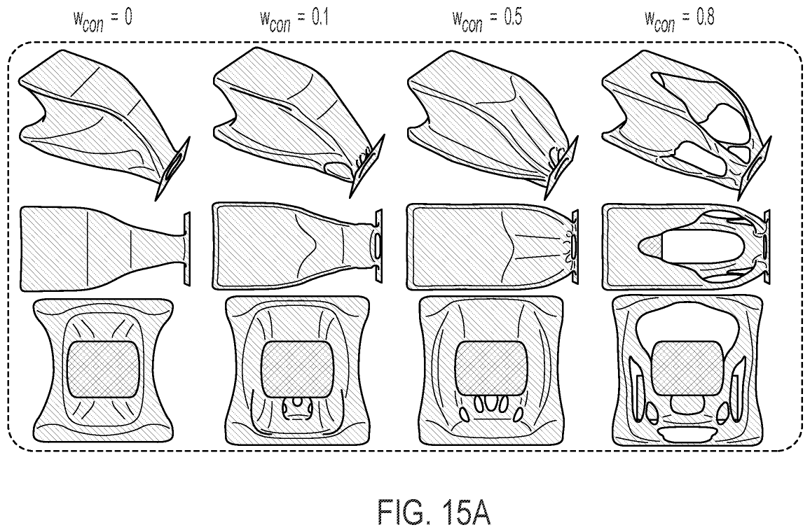

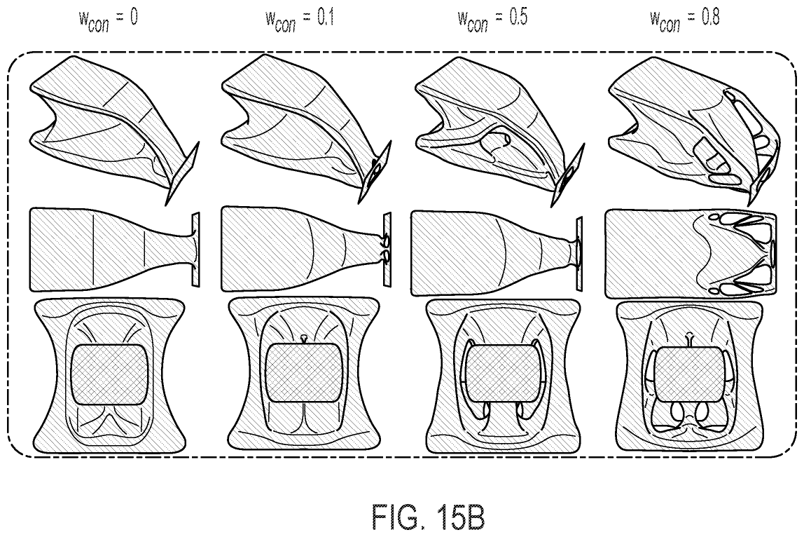

The next example demonstrates the effectiveness of the approach on 3D structural problems where we used the domain shown in FIG. 14. The design is a cantilevered beam where the load is applied at the indicated locations. The design has two inactive domains. The first inactive region is an embedded cylinder that is void except for voxels on the surface of the design domain. The second inactive domain is on the indicated boundary of the design domain and is enforced to be fully dense. There is a region within the second inactive domain that is active, though, and this serves as the outlet for an enforced connection to the inlet on the surface of the voided region. This region is intended to represent an embedded component needing to be connected to another component mounted on the boundary.

We used a target volume fraction of 0.3 and generated designs on a 100×50×50 voxel mesh. We varied w_{con} at the following values: 0, 0.1, 0.5, and 0.8. For each weight, we used both thermal and structural virtual physics to enforce CSC. The resulting parts as well as various views are shown in FIGS. 15A and 15B.

The group in FIG. 15A corresponds with CSC constrained with structural compliance while the group in FIG. 15B corresponds with CSC constrained via thermal compliance. Diagonal hatching indicates the structure, cross hatching indicates the inactive cylinder, and white indicates void. Similar to the 2D results, the 3D cantilevered beam demonstrates the effectiveness of our approach for enforcing CSC regardless of virtual physics. Without considering the connectivity enforcement the inlets and outlet are not connected. At low connectivity weights, connectivity is immediately enforced between inlet and outlet as seen by FIGS. 15A-15B. Qualitatively, it appears that the openings and pathways become wider and wider as the connectivity weight is increased. This feature could be important to consider if wire thickness must be considered. Once again, the normalized compliance relative to the compliance of the unconstrained and unprocessed structure, co, for all the structures is provided by Table. 4. Additionally, the compliance was computed for a structure in which a direct path between inlet and outlet was introduced after initial generation for w_{con}=0.

TABLE 4
Normalized compliance results for the
three generated topologies in 3D

| Design parameters | c/c₀ |
|---|---|
| w_{con} = 0, no post process | 1.00 |
| w_{con} = 0, post-process | 3.55 |
| w_{con} = 0.1, thermal | 1.46 |
| w_{con} = 0.1, structural | 1.04 |
| w_{con} = 0.5, thermal | 1.62 |
| w_{con} = 0.5, structural | 1.25 |
| w_{con} = 0.8, thermal | 2.03 |
| w_{con} = 0.8, structural | 1.30 |

Table 4 once again demonstrates that considering connectivity in the design loop results in more optimal results than if connectivity were enforced by post processing. The decrease in performance is less in 3D because more material paths can be formed when compared to 2D. Importantly the results show that the optimized designs that consider the connectivity constraint are more complex than intuitive modifications done with post-processing.

As discussed previously, the manner in which connectivity was enforced has a few things in common with how the authors incorporated other manufacturing constraints in previous work, in that the global constraints such as accessibility and connectivity are recast into locally evaluable and differentiable forms, leading to sensitivity fields that can be used to guide TO. As a precursor to potential future work, a demonstration of the composability of manufacturing constraints is provided.

For example, consider a case where both accessibility and CSC constraints are considered simultaneously. The example is the same as that of FIG. 11, but an additional constraint is added that ensures all material is accessible for a cutter which approaches a block of raw material from any of the four boundaries. For more details on how accessibility is considered in the design loop see Mirzendehdel, A. M., Behandish, M., and Nelaturi, S., 2020, “Topology Optimization with Accessibility Constraint for Multi-Axis Machining,” Comput.-Aided Des., 122, p. 102825.

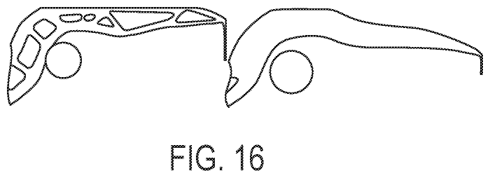

In FIG. 16, a diagram shows resulting geometry of a cantilevered structure when connectivity is enforced (left) and when connectivity and accessibility are enforced (right). Black indicates dense elements, white indicates active void elements, and grey elements are inactive void elements. As can be seen from FIG. 16, when accessibility is considered along with CSC, the design once again drastically changes. All internal structures are eliminated to ensure the material is accessible, but the structure has a similar boundary to enforce the CSC constraint. This example is a clear indication that the general framework shown in FIG. 3 shows promise for accommodating and composing a variety of manufacturing constraints. Future work may include validating this promise with more complex 2D and 3D examples and various combinations of manufacturing constraints.

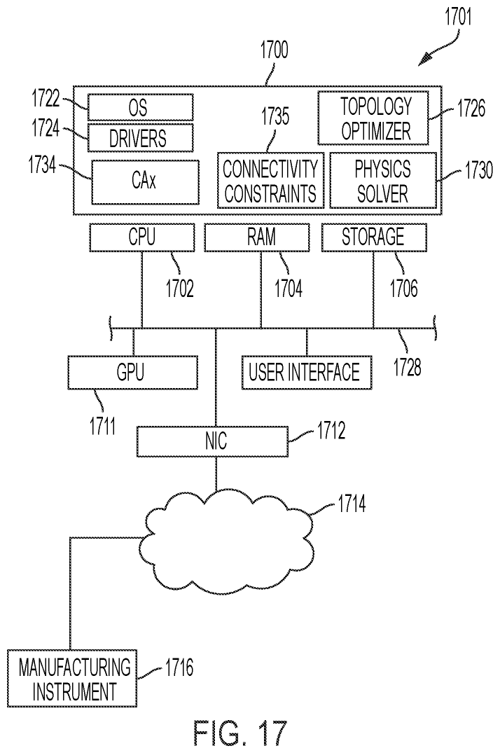

The methods and processes described above can be implemented on computer hardware, e.g., workstations, servers, as known in the art. In FIG. 17, a block diagram shows a system 1701 and computing apparatus 1700 that may be used to implement methods according to an example embodiment. The apparatus 1700 includes one or more processors 1702 such as a central processing unit, co-processor, digital signal processor, etc. The processor 1702 is coupled to memory, which may include both random access memory 1704 and persistent storage 1706, via one or more input/output busses 1708. Other general-purpose or special-purpose hardware may be coupled to the bus 1708, such as graphics processing unit (GPU) 1711 and network interface 1712. Note that the functions of the apparatus 1700 described below may be implemented via multiple devices, e.g., via client-server arrangement, clustered computing, cloud computing, etc.

The network interface 1712 facilitates communications via a network 1714, using wired or wireless media, e.g., with one or more manufacturing instruments 1716. Examples of the manufacturing instrument 1716 include 3D printers, selective laser metal sintering machines, computer numeric controlled (CNC) mills, CNC lathes, CNC laser cutters, CNC water cutters, etc. Data may also be transferred to the manufacturing instrument 1716 using non-network data transfer interfaces, e.g., via portable data storage drives, point-to-point communication, etc.

The apparatus 1700 includes software 1720 such as an operating system 1722 and drivers 1724 that facilitate communications between user-level programs and the hardware. The software 1720 includes a topology optimizer 1726 that receives a definition of a design domain, which may include physical constraints on size, material, orientation, weight, etc. The topology optimizer 1726 uses one or more optimization objectives and/or penalty functions to iteratively change a geometry of the design in order to optimize the topology of a part. The topology optimizer 1726 interfaces with a physics solver 1730 that uses techniques such as finite element analysis, finite different analysis, computational fluid mechanics, etc., to predict physical performance of the part design as it is being optimized.

Generally, the physics solver 1730 uses the physical constraints and inputs (e.g., heat flow, applied forces) to predict a physical performance of the part (e.g., temperatures, deflections, vibrational modes). One or more connectivity constraints 1735 are also used by the physics solver 1730. The connectivity constraints 1735 enforce connectivity to or from at least one region over a complement space of the part. The connectivity constraints 1735 include locally differentiable violation measures that are modeled after at least one of the physical constraints. A topology of the part is optimized using the physics solver 1730 by enforcing the one or more physical constraints and the one or more connectivity constraints 1735 while satisfying a primary objective function of the topology optimizer 1726 that optimizes the physical performance of the part. The topology optimizer 1726 produces a computer-aided design of the part based on the optimized topology. The computer-aided design can be used, e.g., via CAx software 1734 to produce the part via the manufacturing instrument 1716. The CAx software 1734 may include any computer-aided product, such as computer-aided design (CAD), computer-aided manufacturing (CAM), computer-aided engineering (CAE), computer-aided process planning (CAPP), etc. The CAx software 1734 may be used to further develop the part design produced by the topology optimizer 1726, e.g., adding mount points, fluid ports, defining manufacturing processes, producing production drawings, etc.

### 5. Conclusion

In this paper a method for enforcing the connectivity between two points/regions over the complement space of a part was introduced, motivated by a desire to enforce connectivity of embedded components. Then enforcement of connectivity was recast into a “virtual” compliance minimization problem where the precise selection of Neumann and Dirichlet boundary conditions at the desired inlets and outlets enforce the path connectivity of two regions within the complement space. The introduced approach builds on previous work that utilized only Dirichlet boundary conditions that does not enforce connectivity between any two points of interest. More importantly, we demonstrated an effective approach to compose the CSC constraint with physics-based and (potentially) manufacturing constraints of different kinds within iterative TO.

After performing a parameter study of the approach to understand its capabilities and behavior, we integrated it into various structural compliance minimization problems in both 2D and 3D to show how CSC can be enforced. The CSC constrained results were compared to the results of naive postprocessed connection of inlets to outlets. The results indicated that considering connectivity while optimizing for structural compliance resulted in stiffer structures compared to postprocess corrections. Future work should focus on demonstrating connectivity for a variety of TO domains in 2D and 3D beyond minimizing structural compliance.

Additionally, the location of the inlets and outlets was defined a priori but one can easily encounter domains where the best choice for inlet and outlets positions is unclear. Future work should investigate how to actively determine the best location for inlets and outlets in the design loop.

Determining the optimal weightings of the primary and virtual problem is another area of future work. While we demonstrated small weighting can enforce CSC, without drastically impacting performance, the geometry of the connected pathways may not be sufficiently wide for internal wiring or powder removal. By changing the weighting, the size of the pathways, generally, increases which may be desirable. Providing the designer with a systematic approach for selecting the proper weighting based off their needs would be desirable.

From a broader view, the manner in which connectivity was imposed is similar to how other manufacturing constraints can and have been imposed. The constraints are recast into a locally differentiable functions whose sensitivities can augment the primary objective function. In general, this procedure can be repeated for a multitude of constraints creating a general workflow for TO. A simple example of composing connectivity and accessibility within TO was provided to demonstrate the capabilities of the workflow. As more manufacturing constraints are recast locally, they can be seamlessly integrated into a single generative workflow for part design.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The various embodiments described above may be implemented using circuitry, firmware, and/or software modules that interact to provide particular results. One of skill in the arts can readily implement such described functionality, either at a modular level or as a whole, using knowledge generally known in the art. For example, the flowcharts and control diagrams illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to provide the functions described hereinabove.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination are not meant to be limiting, but purely illustrative. It is intended that the scope of the invention be limited not with this detailed description, but rather determined by the claims appended hereto.

1. A method of designing a part, comprising:
defining one or more physical constraints selected from a plurality of physical constraints for the part, the one or more physical constraints for use by a physics solver defining a physical performance of the part;
defining one or more connectivity constraints for use by the physics solver, the one or more connectivity constraints enforcing connectivity to or from at least one region over a complement space of the part, the one or more connectivity constraints comprising locally differentiable violation measures that are modeled after at least one of the physical constraints;
optimizing a topology of the part in the physics solver by enforcing the one or more physical constraints and the one or more connectivity constraints while satisfying a primary objective function that optimizes the physical performance of the part; and
producing a computer-aided design of the part based on the optimized topology, the computer-aided design used to produce the part via a manufacturing instrument.

2. The method of claim 1, wherein the connection is between an inner region of the part and a boundary of the part.

3. The method of claim 1, wherein the connection is between two inner regions of the part.

4. The method of claim 1, wherein the connectivity constraints comprise a virtual load applied on a boundary of the region.

5. The method of claim 1, wherein the connectivity constraints comprise a thermal boundary condition applied on a boundary of the region.

6. The method of claim 1, wherein the one or more connectivity constraints comprise a virtual energy function or a virtual compliance of a hypothetical structure representing the complement space of the part.

7. The method of claim 6, wherein enforcing the one or more connectivity constraints comprises minimizing the virtual energy function.

8. The method of claim 6, wherein the connectivity constraints comprises both Neumann and Dirichlet boundary conditions.

9. The method of claim 1, wherein optimizing the topology further comprises representing the part and the complement space as respective super-level and sub-level sets of a density field.

10. The method of claim 1, further comprising assigning different weights to each of the one or more connectivity constraints and the one or more physical constraints to emphasize one of the physical performance of the part or the connectivity.

11. The method of claim 1, wherein the one or more connectivity constraints ensure accessibility of a manufacturing machine when manufacturing the part.

12. The method of claim 1, wherein the one or more connectivity constraints ensure channels exist in the part.

13. The method of claim 12, wherein the channels are configured for at least one of:
routing wires through the part;
removing powder from the part after a manufacturing process; and
flowing coolant through the part during use of the part.

14. The method of claim 1, wherein the physics solver comprises a finite element solver.

15. A system comprising a memory storing instructions and a processor, the processor operable via the instructions to perform the method of claim 1.

16. A method of designing a part, comprising:
defining a physical constraint for the part, the physical constraint for use by a physics solver defining a physical performance of the part;
defining a connectivity constraint for use by the physics solver, the connectivity constraint enforcing connectivity to or from a region over a hypothetical structure that represents a complement space of the part, the connectivity constraint comprising locally differentiable violation measures that are modeled after one or more physical constraints;
for each intermediate design of the part in an optimization loop:
evaluating a real response based on the physical performance of the part;
evaluating a virtual response based on the connectivity constraints applied to the complement space;
defining a first and second sensitivity fields based respectively on the real response and the virtual response;
weighting the first and second sensitivity fields to relatively emphasize one of the physical performance of the part or the connectivity;
updating the intermediate design based on optimizing an objective function that relates to the physical performance of the part, the optimizing the objective function based on the weighted first and second sensitivity fields; and
determining a convergence criterion that indicates that the updated intermediate design approaches an optimized topology of the part, and terminating the optimization loop with a final design if the convergence criterion meets a threshold; and
after the termination of the optimization loop, producing a computer-aided design of the part based on the final design, the computer-aided design used to produce the part via a manufacturing instrument.

17. The method of claim 16, wherein the connectivity constraint comprises a virtual energy function or a virtual compliance of the hypothetical structure.

18. The method of claim 16, wherein the one or more connectivity constraints ensure channels exist in the part.

19. The method of claim 16, wherein the physics solver comprises a finite element solver.

20. A system comprising a memory storing instructions and a processor, the processor operable via the instructions to perform the method of claim 16.
